(19) United States
(12) Patent Application Publication
(10) Pub. No.: US 2021/0199191 A1
(43) Pub. Date: Jul. 1, 2021

(54) Work Vehicle

(71) Applicant: Yanmar Power Technology Co., Ltd., Osaka (JP)

(72) Inventors: Tomoyuki Kuroda, Osaka (JP); Shinsuke Ozaki, Osaka (JP); Kenichi Miyai, Osaka (JP)

(73) Assignee: Yanmar Power Technology Co., Ltd., Osaka (JP)

(21) Appl. No.: 17/057,670

(22) PCT Filed: Apr. 4, 2019
(86) PCT No.: PCT/JP2019/015000

§ 371 Date: Nov. 22, 2020

(30) Foreign Application Priority Data
May 23, 2018 (JP) 2018-098661

(51) Int. Cl. F16H 59/02; B60K 35/00; B60K 20/08; F16H 63/42; F16H 59/04; G05D 1/02

(52) U.S. Cl. CPC F16H 59/0217; B60K 35/00; B60K 20/08; A01C 11/02; F16H 59/04; G05D 1/0212; F16H 63/42

(57) ABSTRACT

The present invention comprises: a transmission device that shifts output to a travel unit from an engine by changing the position of a slide gear; a motor that changes the position of a ride gear; a cross-lever main transmission lever that is operable in the front-rear and left-right directions and is biased to return to a neutral operation position; and a control device that is configured so as to actuate the motor in response to the front-rear operation of the main transmission lever to switch the shift position of the transmission device and vary the function to be performed by the left-right operation of the main transmission lever according to the shift position of the transmission device.

### TECHNICAL FIELD

The present invention relates to a work vehicle provided with an operation tool for performing a shift operation of a transmission device.

### BACKGROUND ART

Patent Literature 1 discloses a work vehicle provided with a planting operation switch that operates a working unit in association with a forward operation of an operation tool that performs a shift operation of a transmission device, and a planting interlocking switch for switching between a state in which an operation of the working unit is associated with a forward operation by the operation tool, and a state in which the operation is not associated.

In the above work vehicle, the operation tool for performing a shift operation of the transmission device is constituted of levers whose operation ranges are regulated by a lever guide. However, from the viewpoint of reducing the labor of an operator, proposal of an operation tool capable of performing a shift operation more easily is desired. In addition, the planting interlocking switch is used exclusively for switching the interlocking between the operation of the working unit and the forward operation of the operation tool. When another function is given, it is necessary to add equipment such as a planting interlocking switch separately.

### CITATION LIST

### Patent Literature

Patent Literature 1

Japanese Unexamined Patent Application Publication No. 2006-14638

### DISCLOSURE OF INVENTION

### Problems to be Solved by the Invention

The present invention has been made in view of the above problems, and an object of the present invention is to provide a work vehicle capable of easily performing a shift operation by an operation tool, and giving another function according to an operation of the operation tool.

### Means for Solving the Problems

The work vehicle according to the present invention includes: a transmission device that shifts output from a drive source to a travel unit by changing a position of a transmission member; an actuator that changes a position of the transmission member; a cross-lever type operation tool that is operable in front-rear and left-right directions, and is urged to return to a neutral operation position; and a control device that is configured to switch a shift stage of the transmission device by operating the actuator in response to an operation of the operation tool in a front-rear direction, and to have different functions by an operation of the operation tool in a left-right direction according to a shift stage of the transmission device.

According to such a configuration, since a shift stage can be switched according to a forward or backward operation of the cross-lever type operation tool that is urged to return to the neutral operation position, a shift operation by the operation tool becomes easy. Moreover, since the function by the operation of the operation tool in the left-right direction can be changed according to the shift stage of the transmission device, it is possible to give another function according to the operation of the operation tool.

It is preferable that the control device is configured to be able to change a function by an operation of the operation tool in a left-right direction according to a shift stage of the transmission device. Thus, it is possible to change the function when the transmission tool is operated in the left-right direction at a specific shift stage according to the convenience of an operator, and a shift operation by the operation tool becomes easier.

It is preferable that the control device is configured to hold a shift stage immediately before the drive source is stopped, when the drive source is stopped and then restarted. Thus, since it is not necessary to perform a shift operation again when the drive source is restarted, a shift operation by the operation tool becomes easier.

It is preferable that the control device is configured to be able to set a standard mode to be applied when the drive source is stopped and then restarted with respect to combination of a shift stage of the transmission device and a function by an operation of the operation tool in a left-right direction. Thus, since a predetermined standard mode is applied when the drive source is restarted, there is no need of setting a function and the like again after the drive source is restarted, and a shift operation by the operation tool becomes easier.

### BRIEF DESCRIPTION OF DRAWINGS

FIG. 1 is a left side view of a rice planting machine, which is one example of a work vehicle according to the present invention.

FIG. 2 is a control block diagram relating to an operation of a main shift lever.

FIG. 3 is a diagram showing the periphery of a dashboard of a driving operation unit.

FIG. 4 is a perspective view showing a main transmission rod and its periphery.

FIG. 5 is a perspective view showing the periphery of a base end of the main transmission rod.

FIG. 6 is a diagram showing one example of a shift operation pattern by the main shift lever.

FIG. 7 is a diagram showing one example of a screen of a display device.

FIG. 8 is a diagram showing another shift operation pattern by the main shift lever.

FIG. 9 is a diagram showing another shift operation pattern by the main shift lever.

FIG. 10 is a diagram showing another shift operation pattern by the main shift lever.

FIG. 11 is a diagram showing another shift operation pattern by the main shift lever.

FIG. 12 is a diagram showing another shift operation pattern by the main shift lever.

### DESCRIPTION OF EMBODIMENTS

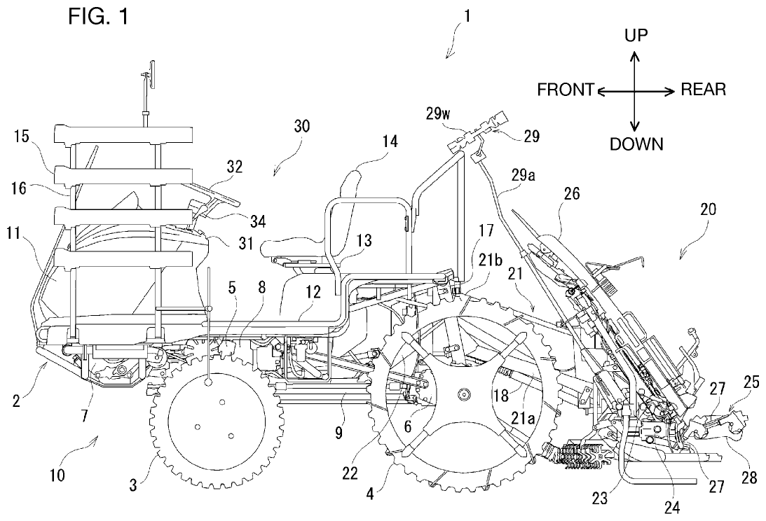

An embodiment of the present invention is described with reference to the drawings. In the present embodiment, a passenger-type rice planting machine 1 shown in FIG. 1 is described as one example of a work vehicle. However, the work vehicle according to the present invention is not limited to this, and may be, for example, an agricultural work machine such as a tractor, a seedling planting machine, and a harvester, or a civil engineering work machine.

### [Overall Structure]

First, an overall structure of the rice planting machine 1 is briefly explained. In FIG. 1, the front-rear direction and the up-down direction of the rice planting machine 1 are indicated by arrows, and a direction perpendicular to the plane of FIG. 1 becomes the left-right direction. The rice planting machine 1 has a travel unit 10, and a planting unit 20 as a working unit. The planting unit 20 is arranged behind the travel unit 10. The planting unit 20 is connected to a rear part of the travel unit 10 via an elevating mechanism 21 to be movable up and down. The rice planting machine 1 is configured to be able to perform a seedling planting (rice planting) operation of planting seedlings by the planting unit 20, while traveling in a field by the travel unit 10.

The travel unit 10 has a traveling body 2, a pair of left and right front wheels 3 that support the traveling body 2, and a pair of left and right rear wheels 4 that also support the traveling body 2. The front wheels 3 are mounted on a front axle that extends from a front axle case 5 to both of the left and right sides thereof. The front axle case 5 is provided on a side of a transmission case 8, and is supported by a front part of the traveling body 2. The rear wheels 4 are mounted on a rear axle that extends from a rear axle case 6 to both of the left and right sides thereof. The rear axle case 6 is provided at a rear end of a tubular frame 9 protruding rearward from the transmission case 8, and is supported by a rear part of the traveling body 2.

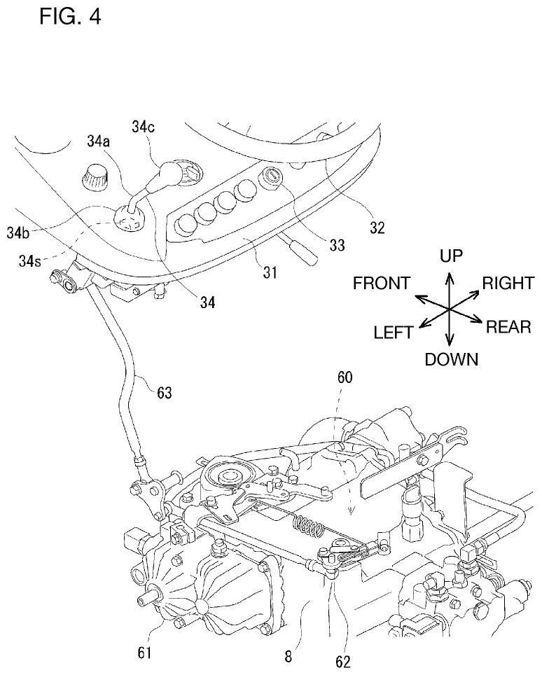

An engine 7, which is a drive source, is mounted on a front part of the traveling body 2. The engine 7 is covered by a bonnet 11. Power of the engine 7 is transmitted to the transmission case 8 arranged behind the engine 7, and is transmitted to the front wheels 3 and the rear wheels 4 via a transmission device 60 (see FIG. 4) housed inside the transmission case 8. By transmitting power to the front wheels 3 and the rear wheels 4, and driving and rotating the front wheels 3 and the rear wheels 4, the travel unit 10 can travel forward or travel backward.

A driving operation unit 30 is provided in a central part of the traveling body 2 in the front-rear direction. An operator steps on a working step 12 (vehicle body cover) provided on an upper surface side of the traveling body 2, and performs a driving operation of the rice planting machine 1 in the driving operation unit 30. A dashboard 31 is provided in a front part of the driving operation unit 30. The dashboard 31 is arranged on an upper surface side of a rear part of the bonnet 11. As will be described later, the dashboard 31 is equipped with a plurality of operation tools including a steering wheel 32. A control seat 14 is installed behind the dashboard 31 via a seat frame 13.

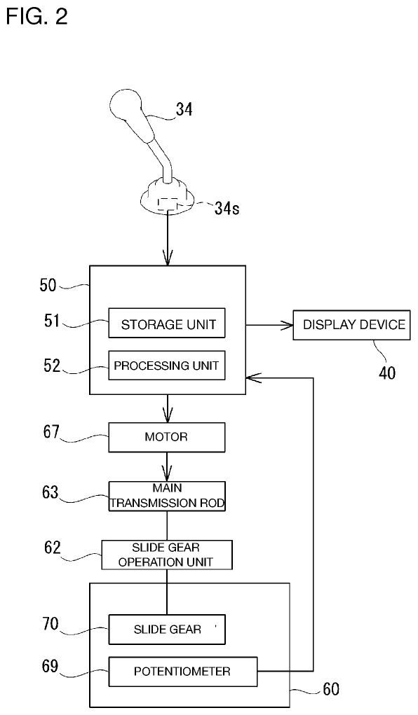

The traveling body 2 is provided with a control device 50 (see FIG. 2), which is not shown in FIG. 1. The control device 50 is configured to control an operation of the rice planting machine 1, based on a signal from a sensor or the like provided in the rice planting machine 1. FIG. 2 schematically shows a part of a function of the control device 50. The control device 50 has a storage unit 51 for storing various pieces of information, and a processing unit 52 for performing processing necessary for various controls, as will be described later.

A link frame 17 stands upright at a rear end of the traveling body 2. The planting unit 20 is connected to the link frame 17 via the elevating mechanism 21 to be movable up and down. The elevating mechanism 21 has a lower link 21a and a top link 21b. A distal end of a rod of a hydraulic elevating cylinder 22 is connected to the lower link 21a. A base end of a cylinder of the elevating cylinder 22 is supported to a rear part of an upper surface of the tubular frame 9 to be pivotable movable up and down. The planting unit 20 is configured to move up and down when the elevating mechanism 21 pivotally moves up and down by expanding and contracting the elevating cylinder 22.

The planting unit 20 includes a planting input case 23 in which power from the engine 7 via the transmission case 8 and a PTO shaft (power transmission shaft) 18 is transmitted, and a plurality of planting driving cases 24 connected to the planting input case 23, a seedling planting mechanism 25 provided on a rear end side of each of the planting driving cases 24, and a seedling stand 26 on which a seedling mat is placed. Spare seedlings to be supplied for seedling supply (seedling replenishment) to the planting unit 20 are placed on spare seedling mounts 15 arranged on both of the left and right sides of the bonnet 11. The spare seedling mounts 15 are mounted on mounting frames 16 standing upright on both of the left and right sides of a front part of the traveling body 2.

The seedling planting mechanism 25 is provided with a rotary case 28 having two planting claws 27, 27 for one row. As the rotary case 28 rotates, the two planting claws 27, 27 alternately take out a seedling from the seeding mat, and plants the seedlings in the field. Since the rice planting machine 1 according to the present embodiment is a rice planting machine for eight-row planting, the rice planting machine 1 is equipped with four sets of eight-row planting driving cases 24 (one set for two rows), and the seedling stand 26 is also configured for eight-row planting. However, the rice planting machine 1 is not limited to this, and may be, for example, a six-row planting or a ten-row planting rice planting machine.

Side markers 29 are provided on left and right outer sides of the planting unit 20, respectively. The side marker 29 includes a marker wheel 29w for drawing a line, and a marker arm 29a that rotatably supports the marker wheel 29w. A base end of the marker arm 20a is supported on left and right outer sides of the planting unit 20 to be pivotable in the left-right direction. The side marker 29 is configured to be displaceable between a landing posture in which a trajectory serving as a reference in a next process is formed on a surface of the field by lowering the marker wheel 29w, and a non-landing posture (see FIG. 1) away from the surface of the filed by raising the marker wheel 29w.

### [Driving Operation Unit]

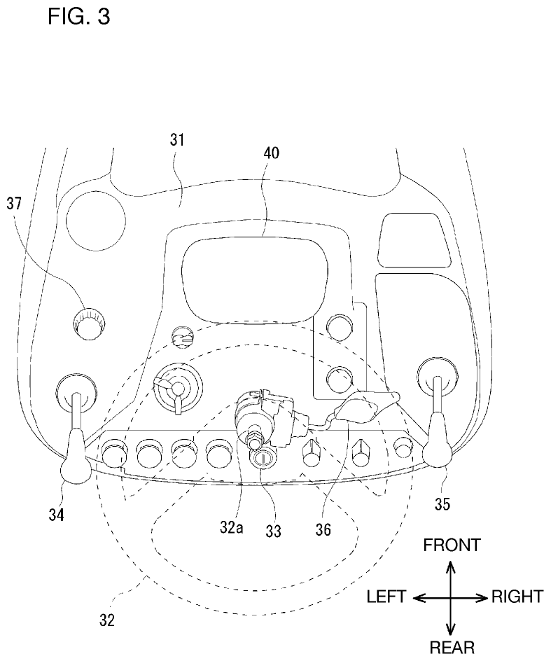

Next, an operation of the driving operation unit 30 is described. As shown in FIG. 3, the steering wheel 32 is arranged at a central part of the dashboard 31 in the left-right direction. The dashboard 31 has, in addition to the steering wheel 32, a plurality of operation tools such as a key switch 33, a main shift lever 34, a work lever 35, and a speed fixing lever 36. Furthermore, a display device 40 for displaying various pieces of information is installed on the dashboard 31. The display device 40 is located in the central part of the dashboard 31 in the left-right direction, and in front of the steering wheel 32. The display device 40 is constituted of a color liquid crystal monitor, but is not limited to this.

The key switch 33 is an operation tool for starting or stopping the engine 7. In the present embodiment, the key switch 33 is arranged at the central part of the dashboard 31 in the left-right direction. The main shift lever 34 is an operation tool for switching a shift stage (gear ratio) of the transmission device 60. In the present embodiment, the main shift lever 34 is arranged at a left end of the dashboard 31 (on the left side of the steering wheel 32). The main shift lever 34 is configured as a cross-lever type operation tool, and details thereof will be described later.

It is preferable that an operation part (a grip portion 34c to be described later) of the main shift lever 34 is arranged on the operator side (specifically, on the rear side) with respect to an axis 32a of the steering wheel 32. Thus, the operator can operate the main shift lever 34 at a nearer position. In addition, since the main shift lever 34 can be placed closer to the center of the dashboard 31 in the left-right direction, while maintaining a circumferential distance required for an operation, the operator can operate the main shift lever 34 at a nearer position.

The work lever 35 is an operation tool for operating the planting unit 20 to move up and down, changing the posture of the side marker 29, and the like. In the present embodiment, the work lever 35 is arranged on a right end of the dashboard 31 (on the right side of the steering wheel 32). The speed fixing lever 36 is an operation tool for fixing a vehicle speed of the rice planting machine 1 (maintaining a set traveling speed), and releasing fixation of the speed. The speed fixing lever 36 is mounted on a shaft of the steering wheel 32, and extends toward the right side.

The work lever 35 is a cross-lever type operation tool that can be tilted in the front-rear and left-right directions, and is urged to return to a neutral operation position. When the work lever 35 is tilted forward once, the planting unit 20 is lowered, and when the work lever 35 is tilted forward once more, power is transmitted to the PTO shaft 18 (specifically, the planting unit 20 is driven), and PTO is turned to an “on” state. On the contrary, when the work lever 35 is tilted backward once, power to the PTO shaft 18 is cut off, and PTO is turned to an “off” state, and when the work lever 35 is tilted backward once more, the planting unit 20 rises. Also, when the work lever 35 is tilted leftward once, the left side marker 29 is turned to a landing posture, and when the work lever 35 is tilted leftward once more, the left side marker 29 returns to the landing posture. Likewise, when the work lever 35 is tilted rightward once, the right side marker 29 is turned to a landing posture, and when the work lever 35 is tilted rightward once more, the right side marker 29 returns to a non-landing posture.

Below the dashboard 31, an unillustrated shift pedal and an unillustrated brake pedal are installed. The shift pedal is an operation tool for changing a vehicle speed of the rice planting machine 1, and more specifically, is an operation tool for changing a rotation speed of the engine 7, and a gear ratio of a hydraulic continuously variable transmission (HST) 61 shown in FIG. 4. The HST 61 constitutes a hydraulic-mechanical continuously variable transmission together with an unillustrated planetary gear device. The brake pedal is an operation tool for braking the rice planting machine 1. Generally, the shift pedal is located at a lower right of the dashboard 31, and the brake pedal is located on the left side of the shift pedal.

### [Shift Operation by Main Shift Lever]

Next, a shift operation by the main shift lever 34 is described. Conventionally, a main shift lever for switching a shift stage of a transmission device is constituted of levers whose operation ranges are regulated by a lever guide. However, the main shift lever 34 provided in the rice planting machine 1 according to the present embodiment is operable in the front-rear and left-right directions, and is configured as a cross-lever type operation tool that is urged to return to a neutral operation position after having been operated forward, backward, leftward, or rightward from the neutral operation position.

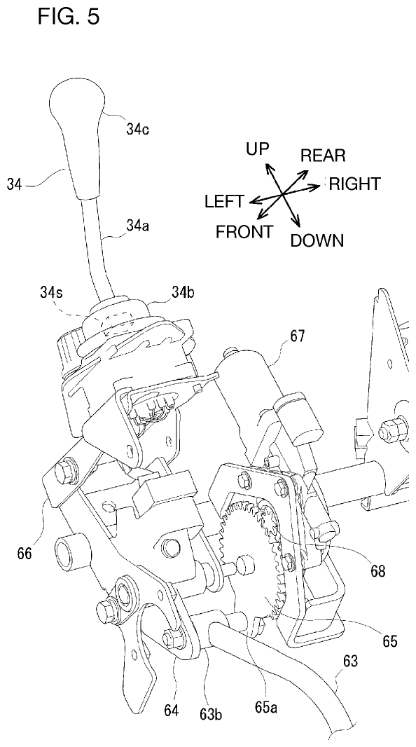

As shown in FIGS. 4 and 5, the main shift lever 34 includes a shaft portion 34a that is tilted only in the front-rear and left-right directions on the dashboard 31, a base portion 34b having a tilting mechanism in the front-rear and left-right directions at a lower end of the shaft portion 34a, and the grip portion 34c provided at an upper end of the shaft portion 34a. A lever position sensor 34s for detecting a tilting operation position of the main shift lever 34 is provided inside the base portion 34b. The tilting operation position of the main shift lever 34 detected by the lever position sensor 34s is transmitted to the control device 50 as a lever position signal (see FIG. 2). The control device 50 actuates the motor 67, based on the lever position signal.

As schematically shown in FIG. 4, the transmission device 60 is installed inside the transmission case 8. The transmission device 60 is provided with a slide gear 70 (see FIG. 2) as a transmission member. Combination of gears that mesh in the transmission device 60 changes depending on a position of the slide gear 70. The transmission device 60 is configured to be able to change power transmitted from the engine 7 via the HST 61 at a plurality of stages according to combination of the gears that mesh with one another. In other words, the transmission device 60 shifts output from the engine 7 to the travel unit 10 by changing a position of the slide gear 70, which is a transmission member. Since the transmission device 60 can be constituted of a known gear-type multiple transmission device, detailed description relating to a structure of the transmission device 60 is omitted.

The slide gear 70 is connected to a slide gear operation unit 62 that is arranged outside the transmission case 8. The slide gear operation unit 62 is connected to a tip end (lower end) of the main transmission rod 63 via a link mechanism. As shown in FIG. 5, a base end 63b (upper end) of the main transmission rod 63 extends axially along the left-right direction, and both ends of the main transmission rod 63 are fixed to a bracket 64 and a protrusion 65a of a sector gear 65, respectively. The bracket 64 is pivotably supported to a column 66 on which the main shift lever 34 is mounted. The sector gear 65 is in mesh with a gear 68 connected to an output shaft of the motor 67.

By actuating the motor 67 and pivotally moving the sector gear 65, the main transmission rod 63 pivotally moves up and down, and the position of the slide gear 70 inside the transmission case 8 can be changed via the slide gear operation unit 62. In this way, the motor 67 is equivalent to an actuator that changes the position of the slide gear 70, which is a transmission member. As described above, the actuation of the motor 67 is controlled by the control device 50. The control device 50 actuates the motor 67 according to an operation of the main shift lever 34 in the front-rear direction, thereby changing the position of the slide gear 70 and switching the shift stage of the transmission device 60.

In the present embodiment, the transmission device 60 is configured to be switchable among four shift stages of “F1”, “F2”, “N” and “R”. In each of “F1” and “F2”, power in the forward direction is transmitted to the travel unit 10. “F1” is a so-called working speed, and the rice planting machine 1 can move forward at a low speed, compared with “F2”. Further, in “F1”, by setting PTO to an “on” state, it is possible to cause the rice planting machine 1 to travel, while performing seedling planting work by driving the planting unit 20. “F2” is a so-called road speed, and the rice planting machine 1 can move forward at a high speed, compared with “F1”. “N” stands for neutral. In “N”, since power is not transmitted to the travel unit 10, the rice planting machine 1 cannot travel. However, it is possible to drive the planting unit 20 by setting PTO to an “on” state. “R” stands for reverse. In “R”, power in the backward direction is transmitted to the travel unit 10, and the rice planting machine 1 can move backward.

As will be described later, in a state that the shift stage is “N”, it is possible to switch a mode to a “seedling supply” mode. Seedling supply is work of adding seedlings (replenishing seedlings) to the seedling stand 26. In the “seedling supply” mode, predetermined control is performed by the control device 50 such that the rotation speed of the engine 7 is changed, or the gear ratio of the HST 61 is not changed even when the shift pedal is operated.

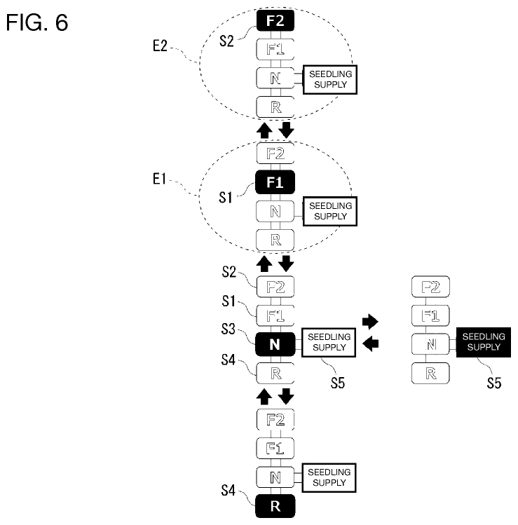

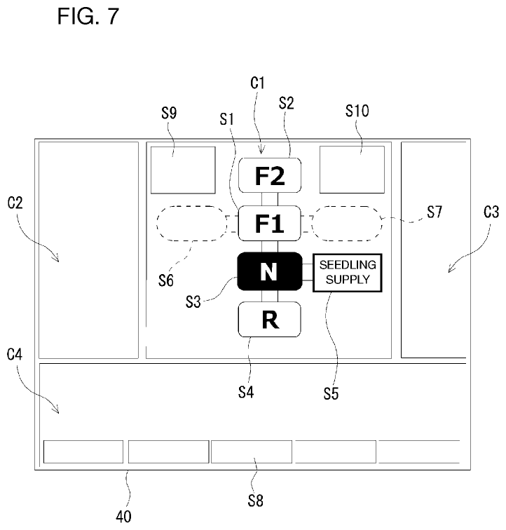

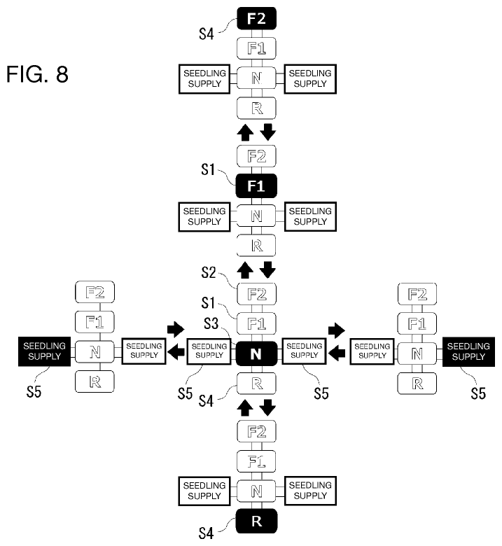

FIG. 6 schematically shows a shift operation pattern by using icons S1 to S5 (see FIG. 7) to be displayed on the display device 40, and arrows indicating operation directions of the main shift lever 34. The icon S1 to S4 correspond to the above-described four shift stages, respectively. The icon S5 corresponds to “seedling supply”. In FIG. 6, icons indicating selected shift stages and functions among the icons S1 to S5 are displayed as hollow squares. Therefore, a portion surrounded by the broken line frame E1 indicates that the shift stage is “F1”, and a portion surrounded by the broken line frame E2 indicates that the shift stage is “F2”. FIGS. 8 to 12 to be described later are also described in accordance with this. The hollow square display indicates highlight display by color, brightness, and the like on a screen of the display device 40.

In FIG. 6, when it is assumed that a state that the shift stage is “N” is a starting point, the shift stage is switched to “F1” by tilting the main shift lever 34 forward once. Also, by tilting the main shift lever 34 backward once in a state that the shift stage is switched to “F1”, the shift stage is switched to “N”. The tilted main shift lever 34 is urged to return to a neutral operating position. However, the shift stage is not switched by returning the main shift lever 34 to the neutral operating position. Switching between “N” and “R”, and switching between “F1” and “F2” are performed similarly to the above. In this way, the control device 50 switches the shift stage of the transmission device 60 according to an operation of the main shift lever 34 in the front-rear direction. In the present embodiment, the four shift stages “F1”, “F2”, “N” and “R” can be switched only by operating the main shift lever 34 in the front-rear direction.

In the present embodiment, when the main shift lever 34 is tilted to the right once in a state that the shift stage is “N”, the mode is switched to the “seedling supply” mode, while maintaining a state that power is not transmitted to the travel unit 10. Also, when the main shift lever 34 is tilted to the left once in a state that the mode is switched to the “seedling supply” mode, the “seedling supply” mode is ended, and the shift stage is returned to an “N” state. In a shift stage other than “N”, even when the main shift lever 34 is tilted to the left or right, such a function is not exhibited. In this way, the control device 50 is configured to have different functions by an operation of the main shift lever 34 in the left-right direction according to a shift stage of the transmission device 60.

In the rice planting machine 1 according to the present embodiment, since the shift stage is switched according to a forward or backward operation of the main shift lever 34, which is a cross-lever type operation tool that is urged to return to a neutral operation position, the shift operation becomes easy. Moreover, since the function by an operation of the main shift lever 34 in the left-right direction can be changed according to a shift stage of the transmission device 60, it is possible to give another function according to an operation of the main shift lever 34. In the example shown in FIG. 6, a function relating to switching to the “seedling supply” mode is given as a function other than the shift function. However, the present embodiment is not limited to this, and it is possible to give another function, such as registration of a point A/B, and turning on/off of autonomous traveling to be described later.

It is preferable that the control device 50 performs control in such a way that PTO is always in an “off” state, while the shift stage is “F2”. This is because, in a normal operation of the rice planting machine 1, a scene that the planting unit 20 is driven in a state that the shift stage is “F2” is not assumed. For a similar reason, it is preferable that the control device 50 performs control in such a way that a shift operation to “N” or “F2” cannot be performed, while PTO in an “on” state in a state that the shift stage is “F1”, specifically, the main shift lever 34 is not input (cancelled) even when the main shift lever 34 is operated in the front-rear direction.

As shown in FIG. 7, information relating to shift stages and functions switchable by operating the main shift lever 34 is displayed on the display device 40. When the shift stage is switched by an operation of the main shift lever 34 in the front-rear direction, or another function is activated by an operation in the left-right direction, the information is updated in association with the operation. Such indication of the display device 40 is controlled by the control device 50. Thus, the operator can visually recognize a switchable shift stage and a switchable function at any time, and make operations while using vision. The function when the main shift lever 34 is operated in the left-right direction differs for each shift stage. However, it is possible to prevent an erroneous operation of the operator by displaying a content of the function on the display device 40.

In the present embodiment, the icons S1, S2, S3, S4 indicating the switchable shift stages (specifically, F1, F2, N, R), and the icon S5 indicating the switchable functions (specifically, seedling supply) according to the shift stages are arranged according to the operation directions of the main shift lever 34. For example, the icon S5 indicating “seedling supply” that can be switched from “N” by tilting the main shift lever 34 to the right is located on the right side of the icon S3 indicating “N”. Therefore, this contributes to an intuitive operation of the operator, and the shift operation by the main shift lever 34 is made easy. Also, although not being shown in the drawings, the icon S1 to S5 are displayed in different colors, and visibility is enhanced. Icons S6 and S7 are not displayed because the icons S6 and S7 are not used in the operation pattern shown in FIG. 6. However, when a function is assigned to the icons S6 and S7, they may also be displayed on the display device 40.

An image of the display device 40 includes a display column C1 for displaying information relating to a shift operation of the main shift lever 34, a display column C2 arranged on the left side of the display column C1, a display column C3 arranged on the right side of the display column C1, and a display column C4 arranged below the display columns C1, C2 and C3. Information to be displayed in each of the display columns C1 to C4 is not particularly limited. It is possible to display various pieces of information, such as an hour meter, a time, a fuel gauge, a seedling use amount, a planting area, and a notification of requesting seeding supply. In the display column C4, a menu icon S8 for shifting to a setting screen to be described later is displayed. A display screen in FIG. 7 is merely one example, and a display content and an image layout are not particularly limited.

In the display column C1, in addition to the icons S1 to S5, icons S9 and S10 indicating respective states of the left and right side markers 29 are displayed. In the display column C1, an icon (icon S3 in FIG. 7) indicating a selected shift stage and a selected function is highlighted and displayed by color, brightness, and the like, and the operator can visually recognize a current state. The same is also applied to the icons S9 and S10. Although the illustration is omitted, information relating to turning on/off of speed fixation, and turning on/off of PTO is also displayed in the display column C1. These pieces of information are displayed by indication of an icon or characters, or inversion of a background color, for example.

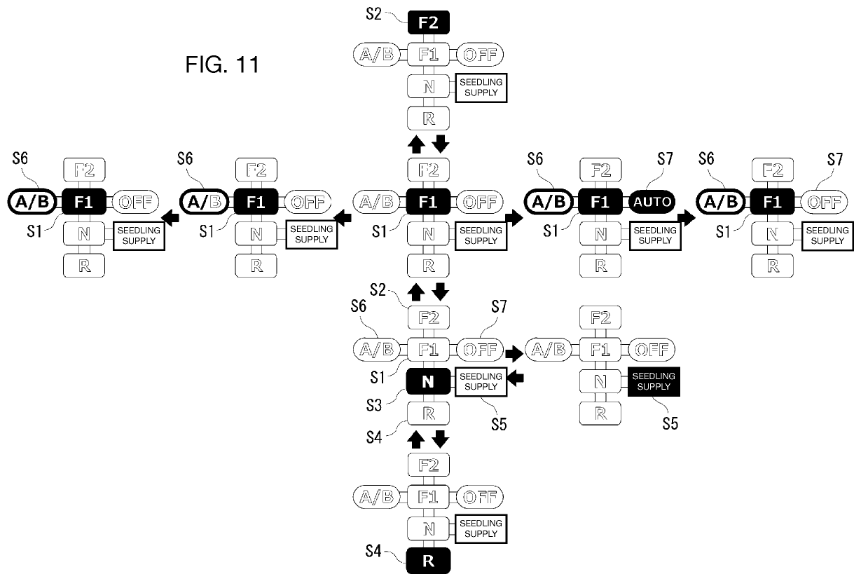

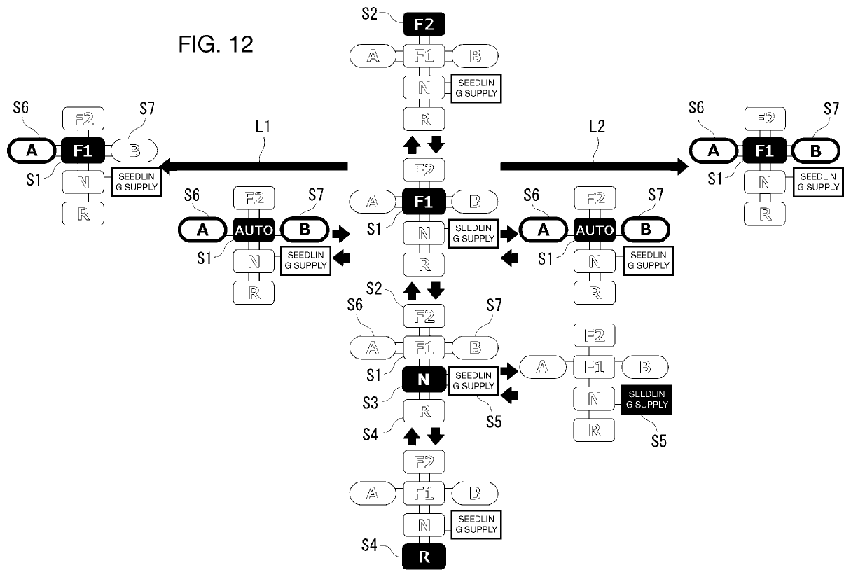

In the present embodiment, the control device 50 is configured in such a way that a function by an operation of the main shift lever 34 in the left-right direction can be changed according to a shift stage of the transmission device 60. For example, in the operation pattern of FIG. 6, when the main shift lever 34 is tilted to the right once in a state that the shift stage is “N”, the mode is switched to the “seedling supply” mode. Alternatively, it is possible to change the setting by enabling switching by tilting the main shift lever 34 to the left, or enabling switching by tilting the main shift lever 34 either to the left or right, as shown in FIG. 8. Further, it is possible to add a function other than the “seedling supply”. In this case, it is possible to set in such a way that switching is enabled from a shift stage other than “N” (see FIGS. 11 and 12).

In the present embodiment, the “seeding supply” mode is set to be switchable only in a state that the shift stage is “N”. However, as an addable function other than the “seedling supply”, the present embodiment is not limited to a function (specific function) that is set to be switchable only by such a specific shift stage. Specifically, it is also possible to add a function (general-purpose function) that is set to be switchable from any shift stage, regardless of the shift stage. As such a general-purpose function, for example, a “horn” mode of outputting a horning sound (horn) is exemplified. In addition to the “horn”, it is possible to add a general-purpose function that is set to be switchable, regardless of a shift stage, as necessary.

When the “horn” mode is added as a general-purpose function that can be switched from each shift stage by tilting the main shift lever 34 in the left-right direction, the “horn” mode becomes a function of calling attention to the front side or the rear side of the traveling body 2 travelling on the road, when the shift stage is switched from the “F2” or “R” state, and the “horn” mode becomes a function of notifying surrounding assist workers of an occurrence of trouble during seedling planting work by assuming that the rice planting machine 1 is traveling for planting, when the shift stage is switched from the “F1” state. Likewise, when the shift stage is switched from the “N” state (when being switched by a tilting operation in a direction different from a direction in which the “seedling supply” mode is set), the “horn” mode becomes a function of notifying the surrounding assist workers of a replenishment timing of agricultural materials of the traveling body 2. In such a case, a level, a magnitude, and a tone of an alarm sound may be changed according to a shift stage at the time of switching.

In this way, by enabling to change a function when the main shift lever 34 is operated in the left-right direction at a specific shift stage according to the convenience of the operator, a shift operation by the main shift lever 34 becomes easier. Such setting change is performed on a predetermined setting screen. It is possible to shift to the setting screen from the menu icon S8 on the screen by operating a select dial 37 (see FIG. 3) of the dashboard 31. Setting information relating to this function change, and setting information relating to a standard mode, which will be described later, are stored in the storage unit 51 of the control device 50.

In the present embodiment, the control device 50 is configured to hold a shift stage immediately before the engine 7 is stopped, when the engine 7 is stopped and then restarted. For example, when the engine 7 is stopped in a state that the shift stage is “F1”, the shift stage at the time of restarting becomes “F1”. In other words, when the engine 7 is stopped in a state that the shift stage is “F1” and then restarted, an operation of the main shift lever 34 in the left-right direction exhibits a function associated with a state that the shift stage is “F1”. Likewise, when the engine 7 is stopped and then restarted also in a state of the other shift stage “F2”, “N”, or “R”, an operation of the main shift lever 34 in the left-right direction exhibits a function associated with a state of a shift stage immediately before the engine 7 is stopped. Thus, there is no need of performing a shift operation again when the engine 7 is restarted, and the shift operation becomes easier. Information relating to a shift stage (specifically, a position of the slide gear 70) immediately before the engine 7 is stopped can be detected, for example, by a potentiometer 69 (see FIG. 2) provided in the transmission device 60.

In the present embodiment, the control device 50 is configured to be able to set the standard mode to be applied when the engine 7 is stopped and then restarted with respect to combination of a shift stage of the transmission device 60 and a function by an operation of the main shift lever 34 in the left-right direction. For example, by setting the operation pattern shown in FIG. 6 as the standard mode, even when the engine 7 is stopped after an operation pattern is changed to the operation pattern shown in FIG. 8, the operation pattern shown in FIG. 6, which is the standard mode, is applied, when the engine 7 is restarted. Therefore, there is no need of setting the standard mode again after the engine 7 is restarted, and a shift operation becomes easier. It is also possible to set the operation patterns shown in FIGS. 8 to 12, for example, as the standard mode. Setting the standard mode is performed on the above-described setting screen.

### [Other Examples of Operation Patterns]

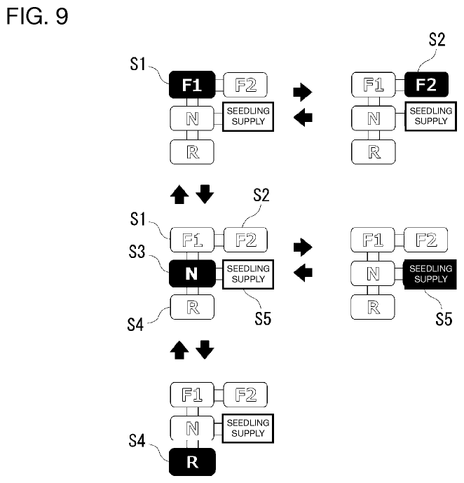

Next, other examples are shown in FIGS. 9 to 12 regarding operation patterns relating to combination of a shift stage of the transmission device 60 and a function by an operation of the main shift lever 34 in the left-right direction. Note that the function to be switched from a specific shift stage is not particularly limited, and it is also possible to add a function other than the functions to be described later.

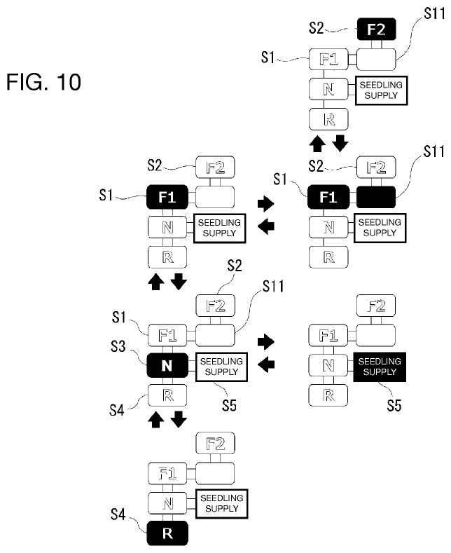

Since each of the operation patterns in FIGS. 9 and 10 is the same as the operation pattern in FIG. 6 except for switching between “F1” and “F2”, differences are described by omitting description on common points. In the operation pattern in FIG. 9, when the main shift lever 34 is tilted to the right once in a state that the shift stage is “F1”, the shift stage is switched to “F2”. Also, when the main shift lever 34 is tilted to the left once in a state that the shift stage is “F2”, the shift stage is switched to “F1”. In this way, a shift operation for switching the shift stage may not only be an operation of the main shift lever 34 in the front-rear direction, but also may partially include an operation of the main shift lever 34 in the left-right direction. However, it is preferable that the three shift stages of “F1”, “N” and “R” are switched only by an operation of the main shift lever 34 in the front-rear direction.

In the operation pattern shown in FIG. 10, an “intermediate” state indicated by an icon S11 is present between “F1” and “F2”. When the main shift lever 34 is tilted to the right once in a state that the shift stage is “F1”, the “intermediate” icon S11 is highlighted and displayed on the screen of the display device 40, but the shift stage remains to be “F1”. Then, by tilting the main shift lever 34 forward once in this state, the shift stage is switched to “F2”. Switching from “F2” to “F1” is similar to the above, and it is necessary to go through the “intermediate” state. However, the shift stage is not switched by the operation to the “intermediate” state. With this configuration, it is possible to prevent an erroneous operation that the operator inadvertently switches the shift stage from “F1” to “F2”. Also, since the icon S2 indicating “F2” is arranged on the upper right of the icon S1 indicating “F1”, it becomes easy for the operator who is accustomed to a shift position of a conventional shift lever to operate.

In the operation pattern shown in FIG. 11, a function relating to straight traveling assist work by autonomous traveling is added. Such autonomous traveling is a technique capable of autonomously traveling straight by generating a linear teaching route that serves as a reference for traveling straight, while acquiring vehicle position information by a satellite positioning system or the like, and is disclosed, for example, in Japanese Unexamined Patent Application Publication No. 2008-67617 by the applicant of the present application. Not only autonomously traveling straight is available, and it is also possible to autonomously turn around a turning route connecting straight traveling routes by using positioning information acquired by a satellite positioning system. According to this technique, it is possible to reduce the burden of the operator, and improve workability by simplifying seedling planting work by the rice planting machine 1. For straight traveling assist work by autonomous traveling, registration of a start point of a teaching route, which is called the point A, registration of an end point of the teaching route, which is called the point B, and an operation of turning on/off autonomous traveling are required.

In the operation pattern shown in FIG. 11, by operating the main shift lever 34 in the left-right direction in a state that the shift stage is “F1”, a function relating to straight traveling assist work by autonomous traveling is exhibited. On the screen of the display device 40, the icon S6 relating to registration of the points A and B is arranged on the left side of the icon S1 indicating “F1”, and the icon S7 relating to turning on/off autonomous traveling is arranged on the right side of the icon S1 (see FIG. 7). Since operations relating to “F2”, “N”, “R” and “seedling supply” are similar to the operation pattern in FIG. 6, overlapping description is omitted.

When the main shift lever 34 is tilted to the left once in a state that the shift stage is “F1”, position of the rice planting machine 1 at the time of the operation is registered as the point A, and the position information of the rice planting machine 1 is stored in the storage unit 51. On the screen of the display device 40, the icon S6 is highlighted and displayed to indicate that the point A is registered. Also, when the main shift lever 34 is tilted to the left once in a state that the point A is registered, position of the rice planting machine 1 at the time of the operation is registered as the point B, and the position information of the rice planting machine 1 is stored in the storage unit 51. On the screen of the display device 40, the icon S6 is highlighted and displayed to indicate that the point B is also registered, in addition to the point A.

Then, after the points A and B are registered, when the main shift lever 34 is tilted to the right once in a state that the shift stage is “F1”, autonomous traveling is turned on. Thus, it is possible to cause the rice planting machine 1 to autonomously travel straight along a route parallel to the teaching route connecting the points A and B. On the screen of the display device 40, the icon S7 is highlighted and displayed to indicate that autonomous traveling is turned on. When the main shift lever 34 is tilted to the right once in a state that autonomous traveling is turned on, autonomous traveling is turned off. On the screen of the display device 40, highlight display of the icon S7 is released to indicate that autonomous traveling is turned off.

In this way, in the present embodiment, not only switching of the “seedling supply” mode, it is possible to provide the main shift lever 34 with the functions other than the shift operation, such as registration of the point A/B, and switching on/off autonomous traveling. Moreover, since these functions are exhibited according to a tilting operation of the main shift lever 34, the operation is easy. In a conventional rice planting machine, it is necessary to install an operation tool for registering the point A/B, and switching on/off autonomous traveling, separately from a main shift lever. However, compared with this, the rice planting machine 1 according to the present embodiment is economical since the number of operation tools can be reduced, and provides excellent workability by an easy operation.

In the example of FIG. 11, the direction in the tilting operation of the main shift lever 34 at the time of registering the point A is the same as the direction (leftward in the present embodiment) in the tilting operation of the main shift lever 34 at the time of registering the point B. Further, the direction in the tilting operation of the main shift lever 34 at the time of turning on/off autonomous traveling is opposite (rightward in the present embodiment) to the direction in the tilting operation of the main shift lever 34 at the time of registering the point A/B. With this configuration, since it is possible to clearly distinguish between the operation at the time of registering the point A/B, and the operation at the time of turning on/off autonomous traveling, it is advantageous in preventing an erroneous operation of the operator. Further, since these functions cannot be operated from a shift stage other than “F1”, it is possible to prevent registration of the point A/B due to an erroneous operation of the operator.

Since the operation pattern in FIG. 12 is the same as the operation pattern in FIG. 11 except for the points to be described below, differences are described by omitting common points. On the screen of the display device 40, the icon S6 relating to registration of the point A is arranged on the left side of the icon S1 indicating “F1”, and the icon S7 relating to registration of the point B is arranged on the right side of the icon S1 (see FIG. 7). Also, the icon S1 indicating “F1” is configured to switch to “AUTO”, which indicates that autonomous traveling is in an on state at the time of turning on autonomous traveling.

When the main shift lever 34 is tilted to the left once in a state that the shift stage is “F1”, position of the rice planting machine 1 at the time of the operation is registered as the point A. However, a long press operation of continuing to tilt the main shift lever 34 for a certain period of time or more (for example, 2 seconds or more) is required. Each of long arrows L1 and L2 shown in FIG. 12 indicates the long press operation. When the point A is registered, the icon S6 is highlighted and displayed on the screen of the display device 40. Also, when the main shift lever 34 is tilted to the right once in a state that the point A is registered, position of the rice planting machine 1 at the time of the operation is registered as the point B. Also in this case, a long press operation is required. When the point B is registered, the icon S7 is highlighted and displayed on the screen of the display device 40.

After the points A and B are registered, when the main shift lever 34 is tilted to the left (or to the right) once in a state that the shift stage is “F1”, autonomous traveling is turned on. In this case, a short press operation of tilting the main shift lever 34 for a period of time less than a certain period of time (for example, less than 2 seconds) is required. This short press operation is a name for distinguishing from the long press operation, and may be a normal tilting operation of the main shift lever 34. When autonomous traveling is turned on, the icon S1 is switched from “F1” to “AUTO” on the screen of the display device 40. Also, when the main shift lever 34 is tilted to the left (or to the right) once in a state that autonomous traveling is turned on, autonomous traveling is turned off. Also in this case, a short press operation is required. When autonomous traveling is turned off, the icon S1 returns from “AUTO” to “F1” on the screen of the display device 40.

In the example of FIG. 12, the direction (leftward in the present embodiment) in which the main shift lever 34 is tilted at the time of registering the point A is a direction opposite to the direction (rightward in the present embodiment) in which the main shift lever 34 is tilted at the time of registering the point B. Therefore, the registration position becomes clear to the operator, which is advantageous in preventing an erroneous operation. Also, it is possible to re-register only the point B, for example. Furthermore, by requiring a long press operation at the time of registering the point A/B, it is possible to prevent position displacement of the point A/B due to an inadvertent operation of the operator.

The present invention is not limited to the above-described embodiment, and various improvements and modifications are available without departing from the spirit of the present invention.

### DESCRIPTION OF REFERENCE NUMERALS

1 rice planting machine

7 engine (drive source)

8 transmission case

10 travel unit

34 main shift lever (operation tool)

40 display device

50 control device

60 transmission device

62 slide gear operation unit

63 main transmission rod

67 motor (actuator)

70 slide gear (transmission member)

1. A work vehicle comprising:
a transmission device that shifts output from a drive source to a travel unit by changing a position of a transmission member;
an actuator that changes the position of the transmission member;
a cross-lever type operation tool that is operable in front-rear and left-right directions, and is urged to return to a neutral operation position; and
a control device that is configured to switch a shift stage of the transmission device by activating the actuator in response to an operation of the operation tool in a front-rear direction, and to have different functions by an operation of the operation tool in a left-right direction according to a shift stage of the transmission device.

2. The work vehicle according to claim 1, wherein
the control device is configured to be able to change a function by an operation of the operation tool in a left-right direction according to a shift stage of the transmission device.

3. The work vehicle according to claim 1, wherein
the control device is configured to hold a shift stage immediately before the drive source is stopped, when the drive source is stopped and then restarted.

4. The work vehicle according to claim 1, wherein
the control device is configured to be able to set a standard mode to be applied when the drive source is stopped and then restarted with respect to combination of a shift stage of the transmission device and a function by an operation of the operation tool in a left-right direction.

5. The work vehicle according to claim 1, further comprising
a display device that displays information relating to a shift stage and a function switchable by an operation of the operation tool, wherein
an icon indicating a shift stage switchable by an operation of the operation tool, and an icon indicating a function switchable according to the shift stage are arranged according to an operation direction of the operation tool on a screen of the display device.

6. The work vehicle according to claim 1, wherein
a function relating to straight traveling assist work by autonomous traveling is included in a function by an operation of the operation tool in a left-right direction.
